(19) United States
(12) Patent Application Publication
(10) Pub. No.: US 2023/0396614 A1
(43) Pub. Date: Dec. 7, 2023

(54) AUTHENTICATION-PERMISSION SYSTEM, EQUIPMENT, AUTHENTICATION-PERMISSION METHOD, AND PROGRAM

(71) Applicant: NIPPON TELEGRAPH AND TELEPHONE CORPORATION, Tokyo (JP)

(72) Inventors: Yusuke IIJIMA, Tokyo (JP); Kan YASUDA, Tokyo (JP); Akira NAGAI, Tokyo (JP); Masami IZUMI, Tokyo (JP)

(21) Appl. No.: 18/249,120

(22) PCT Filed: Oct. 26, 2020
(86) PCT No.: PCT/JP2020/040126

§ 371 Date: Apr. 14, 2023

(51) Int. Cl. H04L 9/40

(52) U.S. Cl. CPC H04L 63/0869; H04L 63/0428

(57) ABSTRACT

An authentication and authorization system according to one embodiment includes: a plurality of devices that perform mutual authentication and authorization by an authentication protocol using ID-based encryption; and an authentication and authorization infrastructure that generates an ID and a private key used for the mutual authentication and authorization, in which the authentication and authorization infrastructure includes: an ID generation unit configured to generate an ID including at least an identifier of the device and information regarding the device; a generation unit configured to generate a private key of the device from the ID; and a distribution unit configured to distribute the ID and the private key to a device corresponding to the identifier included in the ID, and the device includes: a mutual authentication unit configured to perform mutual authentication with another device by using the ID and the private key of the own device; a verification unit configured to verify whether or not a predetermined authorization condition is satisfied by using information regarding a device included in the ID of the own device and information regarding a device included in the ID of the other device when the mutual authentication is performed with the other device; and an authorization unit configured to authorize a request from the other device to the own device when is verified that the authorization condition is satisfied.

### TECHNICAL FIELD

The present invention relates to an authentication and authorization system, a device, an authentication and authorization method, and a program.

### BACKGROUND ART

In a case where Internet of Things (IoT) devices communicate with each other or an IoT device and a gateway device, a server device on a cloud, or the like communicate with each other, first, authentication for mutually verifying validity is performed, and then use of mutual functions, data transmission, and the like are performed. However, it is not preferable in terms of operation to permit use of all functions and data transmission with authentication. Therefore, by giving authorization after authentication, accessible functional data is restricted. For example, a method described in Patent Literature 1 is known as a conventional technique of authentication and authorization in communication between IoT devices.

Incidentally, authorization information generally has an effective period. For example, in a case where an electronic certificate is used as the authorization information, an effective period is specified in the electronic certificate. In this case, the device on the authorization side compares time information synchronized with a network time protocol (NTP) server with an effective period specified in the electronic certificate to verify whether the electronic certificate is within the effective period.

### CITATION LIST

### Patent Literature

Patent Literature 1: WO 2020/080510 A

### SUMMARY OF INVENTION

### Technical Problem

However, for example, there is a device that does not hold time information synchronized with the NTP server due to resource restriction or the like. In addition, for example, in a communication environment with a narrow band such as low power wide area (LPWA), all the devices may not be able to communicate with the NTP server sufficiently and necessary. Therefore, the time information synchronized with the NTP server cannot be referred to, and the effective period related to the authorization cannot be verified in some cases.

One embodiment of the present invention has been made in view of the above points, and an object thereof is to enable verification of an effective period related to authorization.

### Solution to Problem

In order to achieve the above object, according to one embodiment, there is provided an authentication and authorization system including: a plurality of devices that perform mutual authentication and authorization by an authentication protocol using ID-based encryption; and an authentication and authorization infrastructure that generates an ID and a private key used for the mutual authentication and authorization, in which the authentication and authorization infrastructure includes: an ID generation unit configured to generate an ID including at least an identifier of the device and information regarding the device; a generation unit configured to generate a private key of the device from the ID; and a distribution unit configured to distribute the ID and the private key to a device corresponding to the identifier included in the ID, and the device includes: a mutual authentication unit configured to perform mutual authentication with another device by using the ID and the private key of the own device; a verification unit configured to verify whether or not a predetermined authorization condition is satisfied by using information regarding a device included in the ID of the own device and information regarding a device included in the ID of the other device when the mutual authentication is performed with the other device; and an authorization unit configured to authorize a request from the other device to the own device when it is verified that the authorization condition is satisfied.

### Advantageous Effects of Invention

The effective period related to authorization can be verified.

### BRIEF DESCRIPTION OF DRAWINGS

FIG. 1 is a diagram illustrating an overall configuration of an authentication and authorization system in Example 1

FIG. 2 is a diagram illustrating a hardware configuration of an authentication and authorization infrastructure in Example 1.

FIG. 3 is a diagram illustrating a hardware configuration of a device in Example 1

FIG. 4 is a diagram illustrating a functional configuration of the authentication and authorization infrastructure in Example 1.

FIG. 5 is a diagram illustrating a functional configuration of the device in Example 1.

FIG. 6 is a flowchart illustrating distribution processing of an ID and a private key in Example 1.

FIG. 7 is a flowchart illustrating authentication and authorization processing in Example 1.

FIG. 8 is a flowchart illustrating authorization verification processing in Example 1.

FIG. 9 is a diagram illustrating a functional configuration of a device in Example 2.

FIG. 10 is a flowchart illustrating authorization verification processing in Example 2.

FIG. 11 is a flowchart illustrating distribution processing of an ID and a private key in Example 3.

FIG. 12 is a flowchart illustrating authorization verification processing in Example 3.

FIG. 13 is a flowchart illustrating authorization verification processing in Example 4.

### DESCRIPTION OF EMBODIMENTS

Hereinafter, one embodiment of the present invention will be described. In the present embodiment, for example, an authentication and authorization system 1 that enables mutual authentication and verification of an effective period related to authorization when devices communicate with each other even if the devices do not hold time information due to resource restriction or the like will be described. Here, the authentication and authorization system 1 according to the present embodiment uses an authentication protocol by ID-based encryption (hereinafter referred to as “ID-based authentication”) for mutual authentication when devices communicate with each other, and includes time information in the ID, thereby enabling verification of an effective period by the device on the authorization side. Hereinafter, each example of the present embodiment will be described.

### Example 1

First, Example 1 will be described.

<Overall Configuration>

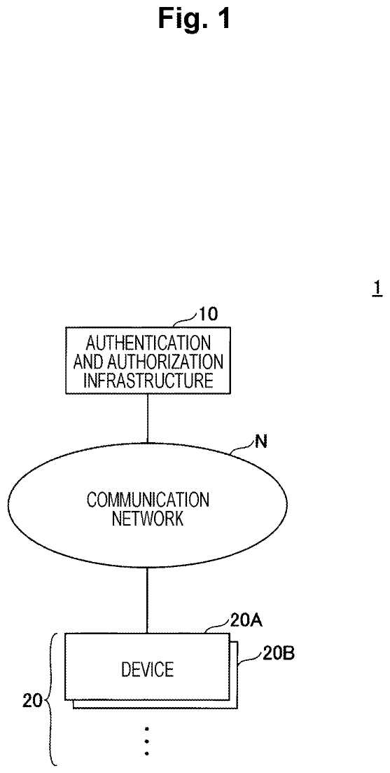

An overall configuration of an authentication and authorization system 1 in Example 1 will be described with reference to FIG. 1. FIG. 1 is a diagram illustrating an overall configuration of the authentication and authorization system 1 in Example 1

As illustrated in FIG. 1, the authentication and authorization system 1 in Example 1 includes an authentication and authorization infrastructure 10 and one or more devices 20. In addition, the authentication and authorization infrastructure 10 and each device 20 are communicatively connected via a communication network N such as the Internet, for example.

The authentication and authorization infrastructure 10 is a computer or a computer system that generates an ID including at least a device identifier for identifying each device 20 and time information, and generates a private key from the ID. That is, the authentication and authorization infrastructure 10 functions as a key generation center (KGC) for ID-based encryption.

Examples of the device 20 include various IoT devices such as various sensor devices and embedded devices, wearable devices, digital home appliances, monitoring camera devices, lighting devices, medical devices, and industrial devices. The device 20 performs mutual authentication with another device 20 via an authentication protocol using ID-based encryption, and verifies an effective period related to authorization. At this time, each device 20 performs mutual authentication with another device 20 using the private key distributed from the authentication and authorization infrastructure 10, and verifies an effective period related to authorization using time information included in the ID.

Hereinafter, each of the plurality of devices 20 will be referred to as a “device 20A”, a “device 20B”, or the like when distinguished from one another. In addition, in a case where the device 20 operates (including access) or uses data, functions, and the like of another device 20, the other device 20 verifies an effective period related to authorization of the device 20, and thus the device 20 (that is, the device 20 on the side that operates data and uses functions) is also referred to as an “authorized device 20”, and the other device 20 (that is, the device 20 on the side that authorizes the authorized device 20 and permits the operation and the use of functions on the data held by the own device 20) is also referred to as an “authorizing device 20”. Note that, for example, since two devices 20 may mutually operate or use data, functions, and the like, one device 20 may become the authorized device 20 and the authorizing device 20.

Here, it is assumed that the device 20 in the present example does not hold time information synchronized with the NTP server due to resource restrictions, a narrow band of a communication environment, or the like. Meanwhile, the present example can be similarly applied to the device 20 holding time information synchronized with the NTP server.

Note that the configuration of the authentication and authorization system 1 illustrated in FIG. 1 is an example, and other configurations may be used. For example, a terminal used by an administrator or the like of the device 20 (hereinafter also referred to as a “device administrator”) may be included in the authentication and authorization system 1. In addition, in a case where the device 20 performs authentication and authorization with some device or apparatus (for example, a gateway device, a server, or the like) other than the device 20, the device or apparatus may be included in the authentication and authorization system 1.

<Hardware Configuration>

A hardware configuration of the authentication and authorization infrastructure 10 and the device 20 in Example 1 will be described.

<<Authentication and Authorization Infrastructure 10>>

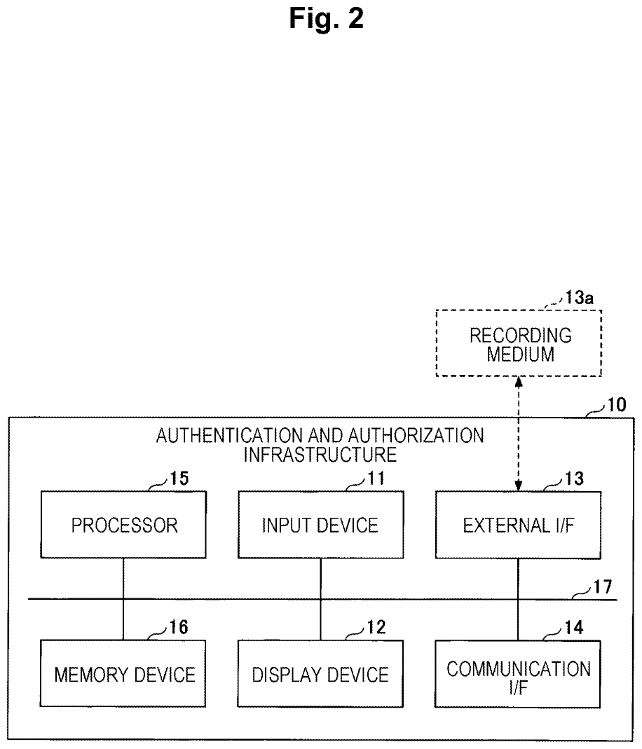

A hardware configuration of the authentication and authorization infrastructure 10 in Example 1 will be described with reference to FIG. 2. FIG. 2 is a diagram illustrating a hardware configuration of the authentication and authorization infrastructure 10 in Example 1.

As illustrated in FIG. 2, the authentication and authorization infrastructure 10 in Example 1 includes an input device 11, a display device 12, an external I/F 13, a communication I/F 14, a processor 15, and a memory device 16. This hardware is communicatively connected via a bus 17.

The input device 11 is, for example, a keyboard, a mouse, a touch panel, or the like. The display device 12 is, for example, a display or the like. Note that the authentication and authorization infrastructure 10 may not include at least one of the input device 11 and the display device 12.

The external I/F 13 is an interface with an external device such as a recording medium 13a. The authentication and authorization infrastructure 10 can, for example, read from and write in the recording medium 13a via the external I/F 13. Examples of the recording medium 13a include a compact disc (CD), a digital versatile disk (DVD), a secure digital memory card (SD memory card), a Universal Serial Bus (USB) memory card, and the like.

The communication I/F 14 is an interface for connecting the authentication and authorization infrastructure 10 to the communication network N. The processor 15 is, for example, any of various arithmetic devices such as a central processing unit (CPU). The memory device 16 is, for example, any of various storage devices such as a hard disk drive (HDD), a solid state drive (SSD), a random access memory (RAM), a read only memory (ROM), and a flash memory.

The authentication and authorization infrastructure 10 in Example 1 having the hardware configuration illustrated in FIG. 2 enables it to realize various types of processing to be described later. Note that the hardware configuration illustrated in FIG. 2 is an example, and the authentication and authorization infrastructure 10 may have another hardware configuration. For example, the authentication and authorization infrastructure 10 may include a plurality of processors 15 or a plurality of memory devices 16.

<<Device 20>>

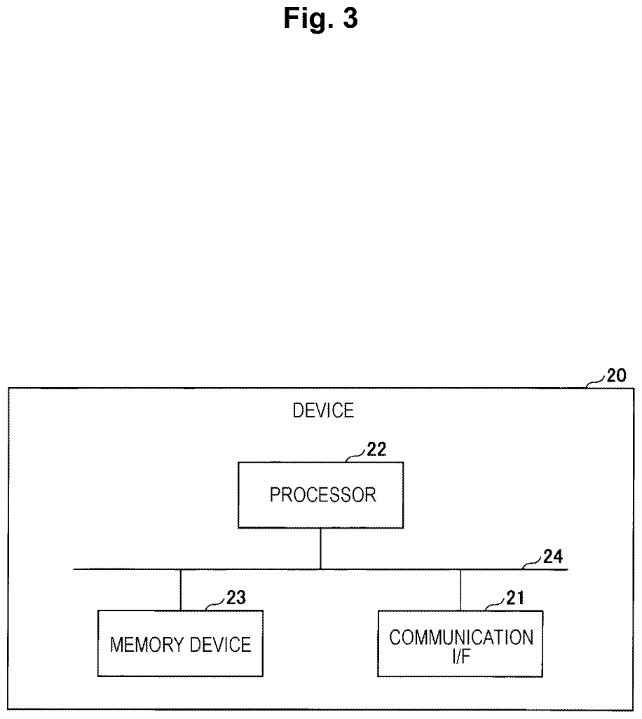

A hardware configuration of the device 20 in Example 1 will be described with reference to FIG. 3. FIG. 3 is a diagram illustrating a hardware configuration of the device 20 in Example 1.

As illustrated in FIG. 3, the device 20 in Example 1 includes a communication I/F 21, a processor 22, and a memory device 23. These pieces of hardware are communicatively connected via a bus 24.

The communication I/F 21 is an interface for connecting the device 20 to the communication network N. The processor 22 is, for example, various arithmetic devices such as a micro processing unit (MPU) and a CPU. The memory device 23 is, for example, various storage devices such as a RAM, a ROM, and a flash memory.

The device 20 in Example 1 having the hardware configuration illustrated in FIG. 3 enables it to realize various types of processing to be described later. Note that the hardware configuration illustrated in FIG. 3 is an example, and the device 20 may have another hardware configuration. For example, the device 20 may include an input device such as various buttons, or may include a display device such as a display panel.

<Functional Configuration>

A functional configuration of the authentication and authorization infrastructure 10 and the device 20 in Example 1 will be described.

<<Authentication and Authorization Infrastructure 10>>

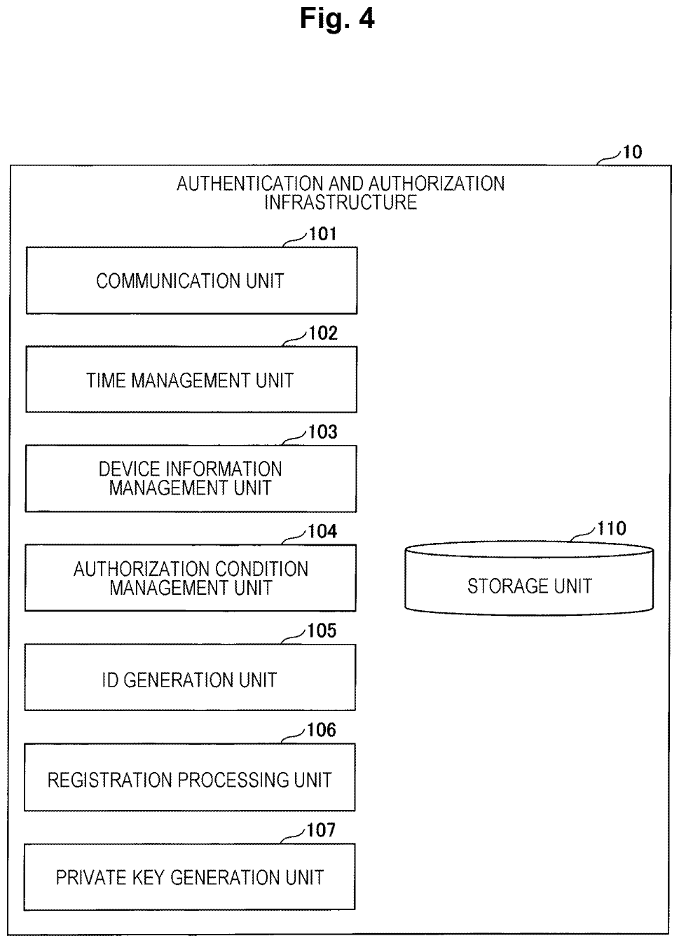

A functional configuration of the authentication and authorization infrastructure 10 in Example 1 will be described with reference to FIG. 4. FIG. 4 is a diagram illustrating a functional configuration of the authentication and authorization infrastructure 10 in Example 1.

As illustrated in FIG. 4, the authentication and authorization infrastructure 10 in Example 1 includes a communication unit 101, a time management unit 102, a device information management unit 103, an authorization condition management unit 104, an ID generation unit 105, a registration processing unit 106, and a private key generation unit 107. Each of these units is realized, for example, by processing executed by the processor 15 by one or more programs installed in the authentication and authorization infrastructure 10.

The authentication and authorization infrastructure 10 in Example 1 includes a storage unit 110. The storage unit 110 is realized by, for example, the memory device 16. Meanwhile, the storage unit 110 may be realized by, for example, a storage device (for example, a database server or the like) communicatively connected to the authentication and authorization infrastructure 10.

The communication unit 101 performs various communications with each device 20 and other devices (for example, a terminal or the like used by a device administrator). The time management unit 102 manages time information synchronized with an external NTP server (that is, information indicating the current time). The device information management unit 103 manages a device identifier of each device 20. Note that, as the device identifier, any information can be used as long as the information can identify the device 20, and for example, a unique manufacturing number or a serial number of the device 20, a number uniquely allocated to the device 20 in the authentication and authorization system 1, or the like can be used.

The authorization condition management unit 104 manages the authorization condition in association with each device 20 (that is, in association with each device identifier). The authorization condition is a condition for the authorizing device 20 to authorize the authorized device 20, and is a condition (for example, “within three days”, “within one day”, or the like) representing an effective period from a reference time in the present example.

The ID generation unit 105 generates an ID including a device identifier, time information, and an authorization condition. The registration processing unit 106 registers an ID related to a request in response to the request from a terminal or the like used by a device administrator, for example. The private key generation unit 107 generates a private key from the ID. The storage unit 110 stores various types of information (for example, time information, a device identifier, an authorization condition, an ID, and the like).

Note that the functional configuration of the authentication and authorization infrastructure 10 illustrated in FIG. 4 is an example, and for example, the authentication and authorization infrastructure 10 may not include either the ID generation unit 105 or the registration processing unit 106.

<<Device 20>>

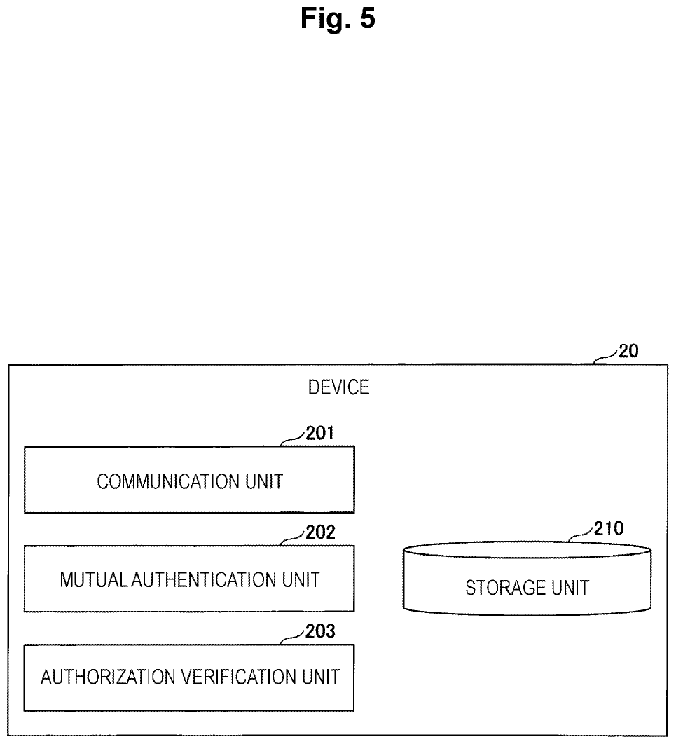

A functional configuration of the device 20 in Example 1 will be described with reference to FIG. 5. FIG. 5 is a diagram illustrating a functional configuration of the device 20 in Example 1

As illustrated in FIG. 5, the device 20 in Example 1 includes a communication unit 201, a mutual authentication unit 202, and an authorization verification unit 203. Each of these units is realized, for example, by processing executed by the processor 22 by one or more programs installed in the device 20.

The device 20 in Example 1 includes a storage unit 210. The storage unit 210 is realized by, for example, the memory device 23.

The communication unit 201 performs various communications with another device 20, the authentication and authorization infrastructure 10, and the like. The mutual authentication unit 202 performs mutual authentication with another device 20 by ID-based authentication using its own ID, private key, or the like. In a case where the mutual authentication with the other device 20 is successful, the authorization verification unit 203 uses its own ID and the ID of the other device 20 to verify the effective period related to the authorization of the other device 20. The storage unit 210 stores various types of information (for example, its own ID, private key, and the like).

<Distribution Processing of ID and Private Key>

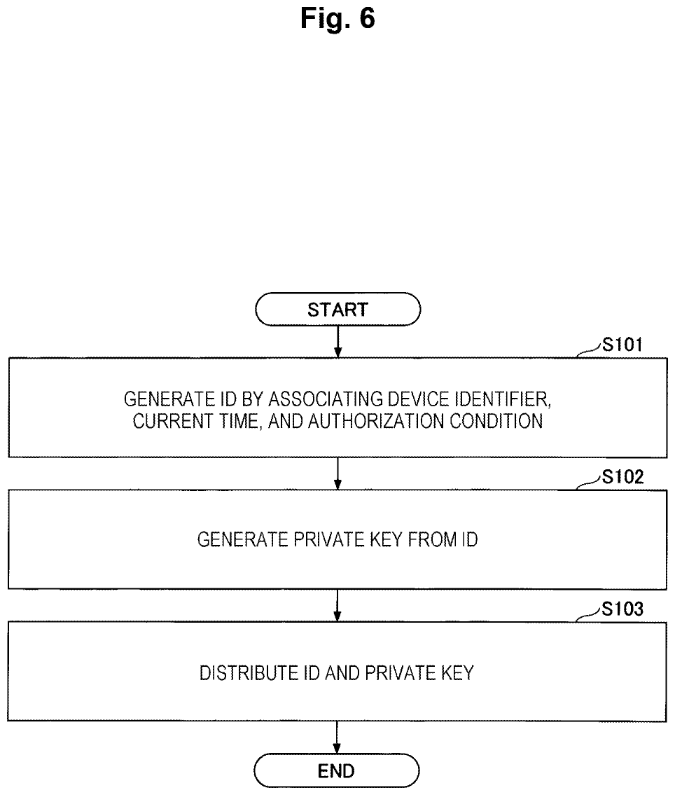

Distribution processing of an ID and a private key in Example 1 will be described with reference to FIG. 6. FIG. 6 is a flowchart illustrating the distribution processing of the ID and the private key in Example 1. Note that the distribution processing of the ID and the private key is preferably executed periodically, for example, every predetermined period.

The ID generation unit 105 generates an ID of each device 20 using the device identifier managed by the device information management unit 103, the time information managed by the time management unit 102, and the authorization condition managed in association with the device identifier by the authorization condition management unit 104 (step S101). Here, the ID generation unit 105 generates an ID by associating, for each device identifier, the device identifier, time information, and an authorization condition corresponding to the device identifier.

For example, in a case where the device identifier is “sensor01”, the time information is a symbol string “202007212137” indicating the current time “21:37 on Jul. 21, 2020”, and the authorization condition is a symbol string “around3 days” indicating “within three days”, it is sufficient if the ID is “sensor01_202007212137_around3 days” or the like. This ID indicates that a device 20 having an ID generated within three days from the time “21:37 on Jul. 21, 2020” is authorized for the device 20 having the device identifier “sensor01”. It is assumed that the meanings of the device identifier and the symbol string constituting the ID are shared by the entire authentication and authorization system 1.

Note that all or part of the ID of each device 20 may be created or generated by a terminal used by a device administrator. In this case, it is sufficient if the registration processing unit 106 registers these IDs (that is, stores them in the storage unit 110 or the like) in response to an ID registration request from the terminal used by the device administrator. At this time, the time information included in the ID may be set in the terminal or may be set (or re-set) in the authentication and authorization infrastructure 10. In addition, the ID may be created not by the terminal but by the device administrator directly operating the authentication and authorization infrastructure 10, for example.

Next, the private key generation unit 107 generates a private key from each ID generated (or registered) in step S101 above (step S102). Here, the private key generation unit 107 generates a private key from the ID by predetermined ID-based authentication. As the ID-based authentication, an arbitrary authentication protocol by ID-based encryption can be used, and for example, Fujioka-Suzuki-Ustaoglu (FSU) or the like can be used.

Then, the communication unit 101 transmits (distributes) each ID generated (or registered) in step S101 above and the private key generated from the ID to the device 20 having the device identifier included in the ID (step S103). When receiving its own ID and private key from the authentication and authorization infrastructure 10, each device 20 stores the ID and the private key in the storage unit 210. Note that the communication unit 101 distributes the ID and the private key to the device 20 by an arbitrary secure method.

<Authentication and Authorization Processing>

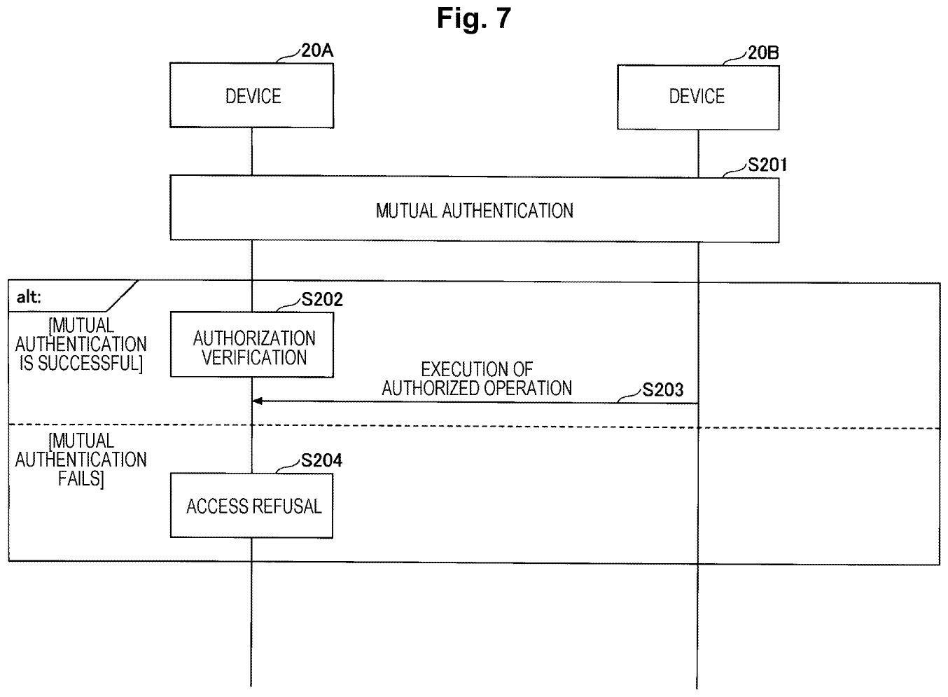

The authentication and authorization processing in Example 1 will be described with reference to FIG. 7. FIG. 7 is a flowchart illustrating authentication and authorization processing in Example 1. Note that authentication and authorization between the device 20A and the device 20B will be described below assuming that the device 20B accesses the device 20A as an example.

First, the mutual authentication unit 202 of the device 20A and the mutual authentication unit 202 of the device 20B perform mutual authentication by predetermined ID-based authentication using the ID and the private key distributed from the authentication and authorization infrastructure 10 (step S201). In a case where the mutual authentication is successful, the device 20A and the device 20B mutually input IDs of the other side.

In a case where the mutual authentication is successful in step S201 above, the authorization verification unit 203 of the device 20A verifies the effective period related to the authorization of the device 20B using the ID of the device 20B and its own ID, and determines whether or not the device 20B is authorized (step S202). Note that details of the processing (authorization verification processing) of step S202 will be described later.

Then, in a case where it is determined in step S202 that the authorization is granted, the communication unit 201 of the device 20B requests execution of the authorized operation (step S203). In the present example, it is assumed that the authorized operation is determined in advance.

On the other hand, in a case where the mutual authentication fails in step S201, the mutual authentication unit 202 of the device 20A refuses the access from the device 20B (step S204).

<Authorization Verification Processing>

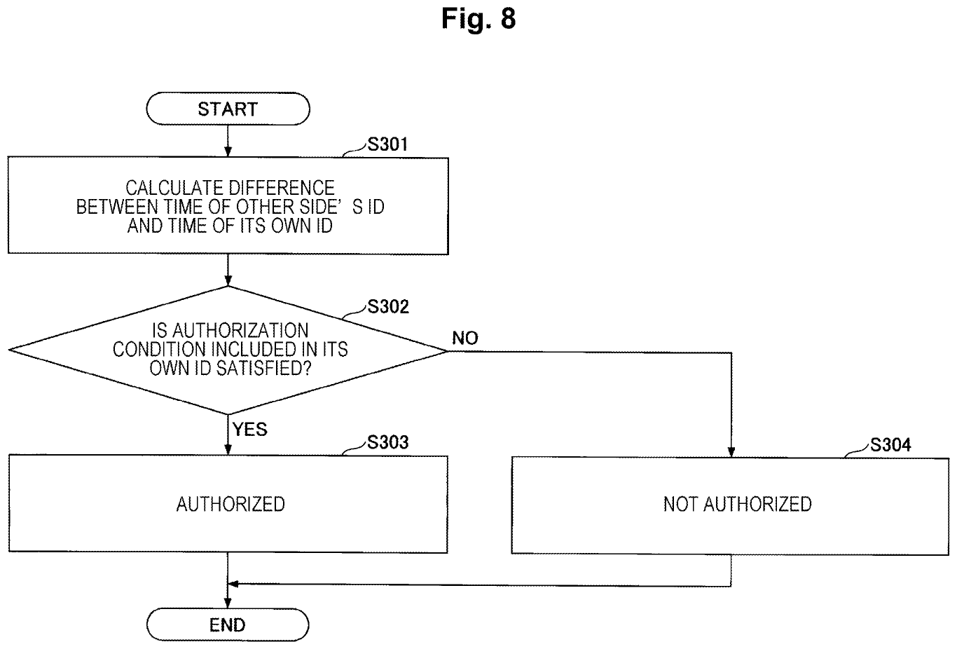

The authorization verification processing (authorization verification processing in step S202 above) in Example 1 will be described with reference to FIG. 8. FIG. 8 is a flowchart illustrating the authorization verification processing in Example 1.

The authorization verification unit 203 of the device 20A calculates a difference between the time indicated by the time information included in the ID of the device 20B and the time indicated by the time information included in its own ID (step S301). Note that this difference accurately means a difference in date and time based on the time information included in its own ID.

Next, the authorization verification unit 203 of the device determines whether or not the difference calculated in step S301 above satisfies the authorization condition included in its own ID (step S302).

Then, the authorization verification unit 203 of the device determines that the device 20B is authorized in a case where it is determined that the authorization condition is satisfied in step S302 above (step S303), and determines that the device 20B is not authorized in a case where it is determined that the authorization condition is not satisfied in step S302 above (step S304).

For example, it is assumed that the ID of the device 20A is “sensor01_202007212137_around3 days” and the ID of the device 20B is “sensor02_202007221630_around1day”. In this case, a difference between “202007221630” and “202007212137” is calculated in step S301 above, and it is determined in step S302 above whether or not the difference satisfies the authorization condition “around3 days” (that is, within three days). In this example, since the difference between “202007221630” and “202007212137” is within three days, it is determined that the device 20B is authorized.

On the other hand, for example, in a case where the ID of the device 20A is “sensor01_202007212137_around3 days” and the ID of the device 20B is “sensor02_202007251630_around1day”, it is determined that the device 20B is not authorized.

In this way, in the present example, the time information is embedded in the ID (in other words, an ID distributed from a trusted authority) distributed from the authentication and authorization infrastructure 10, and the time information of the ID of the authorizing device 20 and the ID of the authorized device 20 is compared with each other in the authorizing device 20 to verify the presence or absence of the authorization. As a result, even in a case where the device 20 does not hold the time information synchronized with the NTP server, it is possible to verify the effective period related to the authorization.

### Modification 1

In the present example, the authorizing device 20 refers only to its own ID. However, for example, in a case where the time information included in the ID of the authorized device 20 is larger than the time information included in the ID of the authorizing device 20 (that is, in a case where the time information advanced by the ID of the authorized device 20 is included), the time information included in the ID of the authorizing device 20 may be updated with the time information included in the ID of the authorized device 20. As a result, the authorizing device 20 can perform the authorization verification using the ID including the updated time information from the next time.

### Modification 2

In order to further enhance safety, the authentication and authorization infrastructure 10 and each device 20 may be configured by a secure processor. The secure processor is a processor that operates in an execution environment divided into a secure area and a non-secure area. In general, all data exchange via a communication path is performed in the non-secure area, and the mechanism is such that access from the non-secure area to the secure area is not possible. With this mechanism, in the secure processor, falsification or fraud of data, program binary, or the like stored in the secure area is prevented.

In a case where the authentication and authorization infrastructure 10 includes a secure processor, each functional unit included in the authentication and authorization infrastructure 10 is executed on the secure area. Similarly, in a case where the device 20 includes a secure processor, each functional unit of the device 20 is executed on the secure area. In addition, an ID, a private key, and the like are also stored in the secure area.

### Modification 3

In the present example, the authorization condition is included in the ID, but the authorization condition may not be included in the ID in a case where the authorization condition is not changed by the distribution of the ID. In this case, it is sufficient if each device 20 stores the authorization condition in the storage unit 110 in advance, and uses the authorization condition in the authorization verification processing. As a result, the length of each ID can be shortened. For example, in a case where the device identifier is “sensor01” and the time information is a symbol string “202007212137” indicating the current time “21:37 on Jul. 21, 2020”, the ID is “sensor01_202007212137” or the like, and the length of the ID can be shortened.

### Example 2

Next, Example 2 will be described. In Example 2, a case will be described in which an elapsed time from distribution of an ID and a private key is measured by each device 20, and a current time is calculated by adding the elapsed time to time indicated by time information included in the ID. As a result, in Example 2, it is possible to more accurately verify the effective period related to the authorization regardless of the interval at which the ID is distributed.

In Example 2, differences from Example 1 will be described, and the description of the same components as those of Example 1 will be omitted. That is, components not described in the present example may be similar to those in Example 1.

<Functional Configuration>

<<Device 20>>

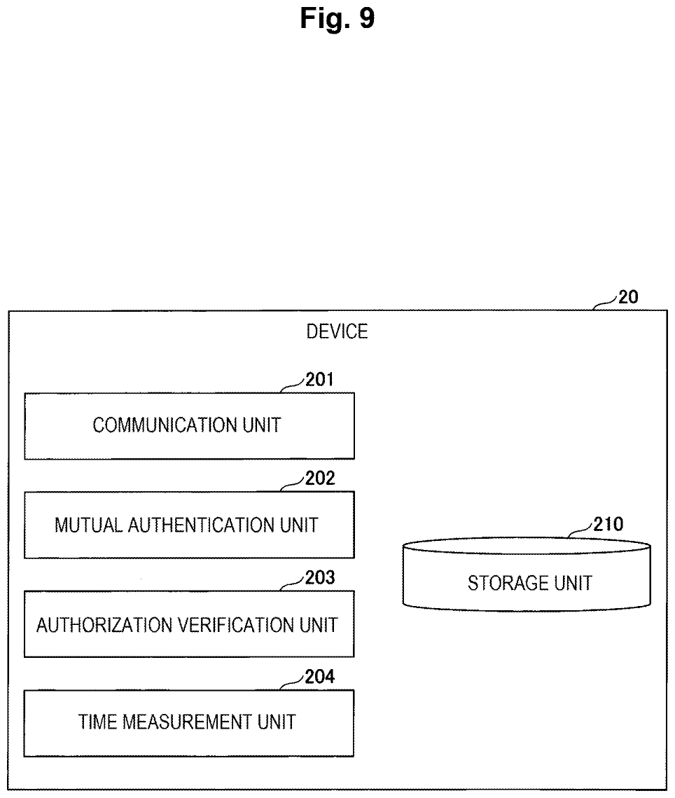

A functional configuration of the device 20 in Example 2 will be described with reference to FIG. 9. FIG. 9 is a diagram illustrating a functional configuration of the device 20 in Example 2.

As illustrated in FIG. 9, the device 20 in Example 2 further includes a time measurement unit 204. The time measurement unit 204 is realized, for example, by processing executed by the processor 22 by one or more programs installed in the device 20.

The time measurement unit 204 measures an elapsed time (that is, a temporal change in the state of the device 20) from the time when its own ID and private key are received from the authentication and authorization infrastructure 10. When newly receiving its own ID and private key from the authentication and authorization infrastructure 10, the time measurement unit 204 resets the elapsed time measured so far and then newly measures the elapsed time.

<Authorization Verification Processing>

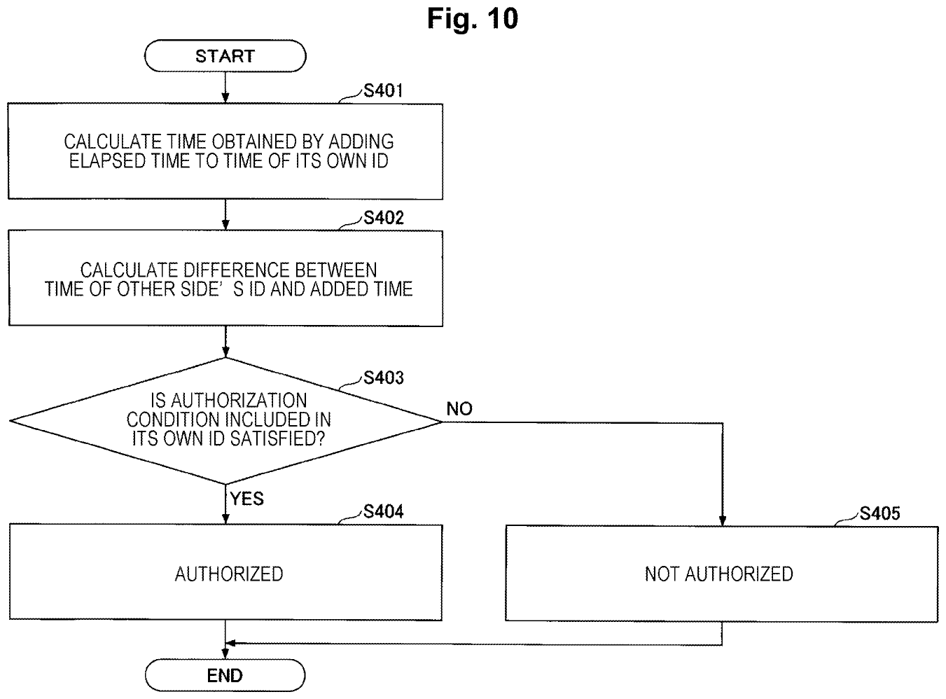

The authorization verification processing (authorization verification processing in step S202 in FIG. 7) in Example 2 will be described with reference to FIG. 10. FIG. 10 is a flowchart illustrating the authorization verification processing in Example 2. Note that, in the authorization verification processing illustrated in FIG. 10, as in the case of Example 1, as an example, it is assumed that the device 20A is the authorizing device 20, and the device 20B is the authorized device 20.

The authorization verification unit 203 of the device 20A calculates time obtained by adding the elapsed time measured by the time measurement unit 204 to the time indicated by the time information included in its own ID (hereinafter also referred to as an added time) (step S401). Since the elapsed time is time elapsed from the time when the ID and the private key are received, the added time is the current time (alternatively, time close to the current time).

Next, the authorization verification unit 203 of the device calculates a difference between the time indicated by the time information included in the ID of the device 20B and the added time calculated in step S401 above (step S402).

Next, the authorization verification unit 203 of the device determines whether or not the difference calculated in step S402 above satisfies the authorization condition included in its own ID (step S403).

Then, the authorization verification unit 203 of the device determines that the device 20B is authorized in a case where it is determined that the authorization condition is satisfied in step S403 above (step S404), and determines that the device 20B is not authorized in a case where it is determined that the authorization condition is not satisfied in step S403 above (step S405).

For example, it is assumed that the ID of the device 20A is “sensor01_202007212137_around3 days”, the ID of the device 20B is “sensor02_202007221630 around1day”, and the elapsed time measured by the time measurement unit 204 of the device 20A is 3 hours. In this case, in step S401 above, the added time “202007220037” obtained by adding 3 hours to “202007212137” is calculated, in step S402 above, the difference between “202007221630” and “202007220037” is calculated, and in step S403 above, it is determined whether or not the difference satisfies the authorization condition “around3 days” (that is, within three days). In this example, since the difference between “202007221630” and “202007220037” is within three days, it is determined that the device 20B is authorized.

On the other hand, for example, in a case where the ID of the device 20A is “sensor01_202007212137_around3 days” and the ID of the device 20B is “sensor02_202007251630_around1day”, it is determined that the device 20B is not authorized.

In this way, in the present example, the time information included in the ID of the authorizing device 20 is corrected by the elapsed time from the time when the ID is received. As a result, it is possible to more accurately verify the effective period related to the authorization as compared with Example 1.

### Modifications

Although the time information is included in the ID in the present example, position information may be included in the ID instead of the time information (or together with the time information.). That is, when the ID is distributed to the device 20, position information (or, in addition, the current time) indicating the position of the device 20 at the time of ID distribution may be included in the ID. By including the position information in the ID, each device 20 can estimate or specify the current position from the position information included in its own ID by measuring a movement distance (that is, a positional change of the state of the device 20) by a measurement unit realized by, for example, an acceleration sensor, a global positioning system (GPS), or the like. Therefore, for example, the authorization verification unit 203 of the device 20A can also perform the authorization verification by calculating a difference between its own current position and the position indicated by the position information included in the ID of the device 20B and determining whether or not the difference satisfies the authorization condition regarding the position. Note that the authorization condition regarding the position is, for example, a condition regarding the position or distance such as “distance is within 100 m”.

Note that arbitrary information regarding the device (that is, arbitrary information (for example, the remaining battery level, the radio wave reception strength, the date of manufacture, the model number, the device administrator, information indicating the connection destination of the device, and the like) indicating the state of the device other than the time and the position) may be used in addition to the time information and the position information.

### Example 3

Next, Example 3 will be described. In Example 3, a case where there are a plurality of objects to be authorized for one device 20 and there is an authorization condition for each of the plurality of objects to be authorized will be described. Here, the objects to be authorized are data, a function, or the like authorized by the authorizing device 20, and include, for example, browsing of internal data, use of a certain specific function, or the like.

In Example 3, differences from Example 1 will be described, and the description of the same components as those of Example 1 will be omitted. That is, components not described in the present example may be similar to those in Example 1.

<Distribution Processing of ID and Private Key>

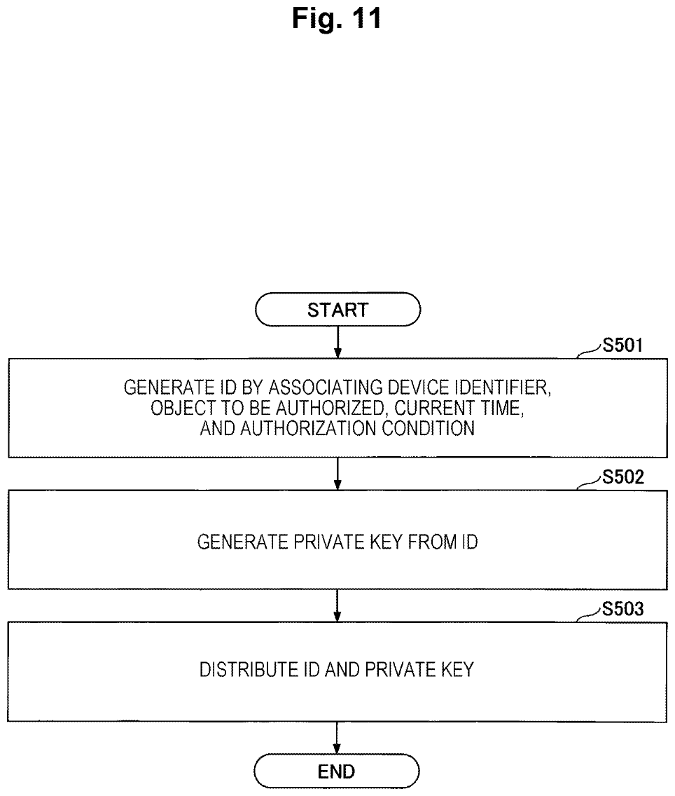

Distribution processing of an ID and a private key in Example 3 will be described with reference to FIG. 11. FIG. 11 is a flowchart illustrating the distribution processing of the ID and the private key in Example 3. Note that the distribution processing of the ID and the private key is preferably executed periodically, for example, every predetermined period.

The ID generation unit 105 generates an ID of each device 20 using the device identifier managed by the device information management unit 103, the time information managed by the time management unit 102, and the object to be authorized and the authorization condition managed in association with the device identifier by the authorization condition management unit 104 (step S501). Here, in the present example, it is assumed that the authorization condition management unit 104 manages one or more objects to be authorized and authorization conditions thereof for each device identifier in association with the device identifier. Therefore, the ID generation unit 105 generates an ID by associating, for each device identifier, the device identifier, time information, and one or more objects to be authorized and authorization conditions thereof corresponding to the device identifier.

For example, in a case where the device identifier is “sensor01”, the time information is a symbol string “202007212137” indicating the current time “21:37 on Jul. 21, 2020”, the first object to be authorized is a symbol string “senddata” indicating “data transmission”, the authorization condition corresponding to the object to be authorized “data transmission” is a symbol string “around3 days” indicating “within three days”, the second object to be authorized is a symbol string “attempt” indicating “device operation”, and the authorization condition corresponding to the object to be authorized “device operation” is a symbol string “around1day” indicating “within one day”, it is sufficient if the ID is “sensor01_202007212137 senddata around3 days attempt around1day” or the like. This ID indicates that the device 20 having an ID generated within three days from the time “21:37 on Jul. 21, 2020” is authorized to “transmit data” to the device 20 having the device identifier “sensor01”, and the device 20 having an ID generated within one day is authorized to “operate the device”. It is assumed that the meanings of the device identifier and the symbol string constituting the ID are shared by the entire authentication and authorization system 1

Subsequent steps S502 and S503 are similar to steps S102 and S103 in FIG. 6.

<Authorization Verification Processing>

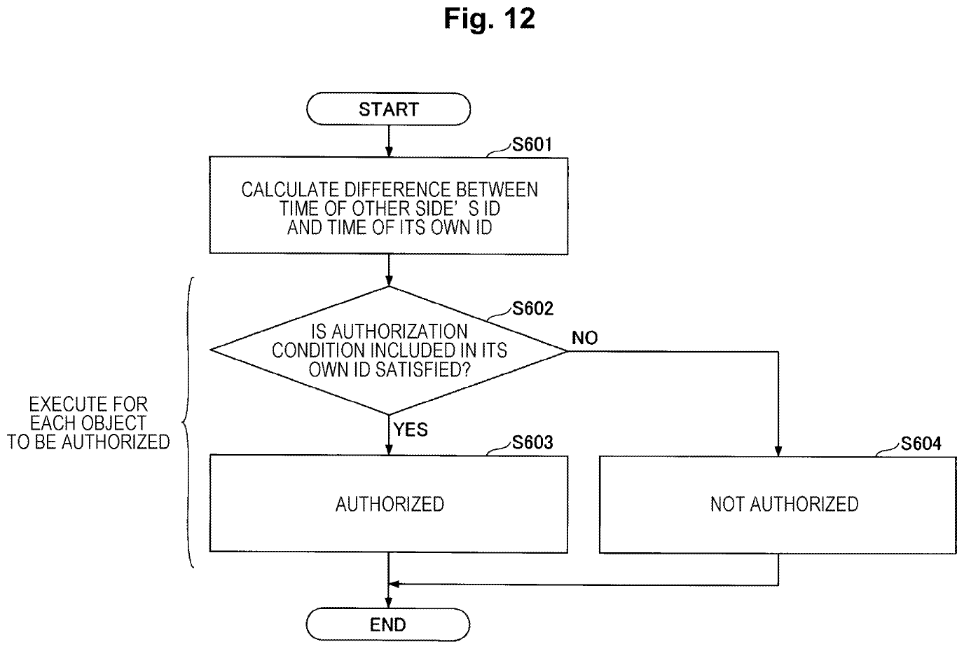

The authorization verification processing (authorization verification processing in step S202 in FIG. 7) in Example 3 will be described with reference to FIG. 12. FIG. 12 is a flowchart illustrating the authorization verification processing in Example 3. Note that, in the authorization Verification processing illustrated in FIG. 12, as in the case of Example 1, as an example, it is assumed that the device 20A is the authorizing device 20, and the device 20B is the authorized device 20.

The authorization verification unit 203 of the device 20A calculates a difference between the time indicated by the time information included in the ID of the device 20B and the time indicated by the time information included in its own ID (step S601).

Subsequent steps S602 to S604 are executed for each object to be authorized.

The authorization verification unit 203 of the device 20A determines whether or not the difference calculated in step 601 above satisfies the authorization condition corresponding to the object to be authorized among the authorization conditions included in its own ID (step S602).

Then, the authorization verification unit 203 of the device 20A determines that the device 20B is authorized for the object to be authorized in a case where it is determined that the authorization condition is satisfied in step S602 above (step S603), and determines that the device 20B is not authorized for the object to be authorized in a case where it is determined that the authorization condition is not satisfied in step S602 above (step S604).

For example, it is assumed that the ID of the device 20A is “sensor01_202007212137 senddata around3 days attempt around1day” and the ID of the device 20B is “sensor02_202007231630 around1day” In this case, steps S602 to S604 related to the object to be authorized “senddata” and steps S602 to S604 related to the object to be authorized “attempt” are respectively executed. On the other hand, the difference between “202007231630” and “202007212137” satisfies the authorization condition “within three days”, but does not satisfy the authorization condition “within one day”. Therefore, in this example, the device 20B is determined to be authorized for the object to be authorized “senddata” and not to be authorized for the object to be authorized “attempt”.

In this way, in the present example, the authorization condition is also included in the ID for each object to be authorized. As a result, for example, even in a case where it is desired to authorize only a part of data or functions held by the authorizing device 20, it is possible to flexibly perform authorization.

Note that, in the present example, data, functions, and the like authorized by the authorizing device 20 are set as the object to be authorized, and a symbol string representing such an object to be authorized is included in the ID. However, the present invention is not limited thereto, and for example, an identifier of the object to be authorized may be included in the ID, or a device identification of the authorized device 20 may be included in the ID as the object to be authorized.

### Example 4

Next, Example 4 will be described. In Example 4, a case where the authorizing device 20 performs authorization verification with reference to an authorization condition included in an ID of the authorized device 20 will be described. As a result, for example, by treating the authorization condition as a condition representing the expiration period of the ID, it is possible to verify whether or not the ID of the authorized device 20 has been revoked.

In Example 4, differences from Example 1 will be described, and the description of the same components as those of Example 1 will be omitted. That is, components not described in the present example may be similar to those in Example 1.

<Authorization Verification Processing>

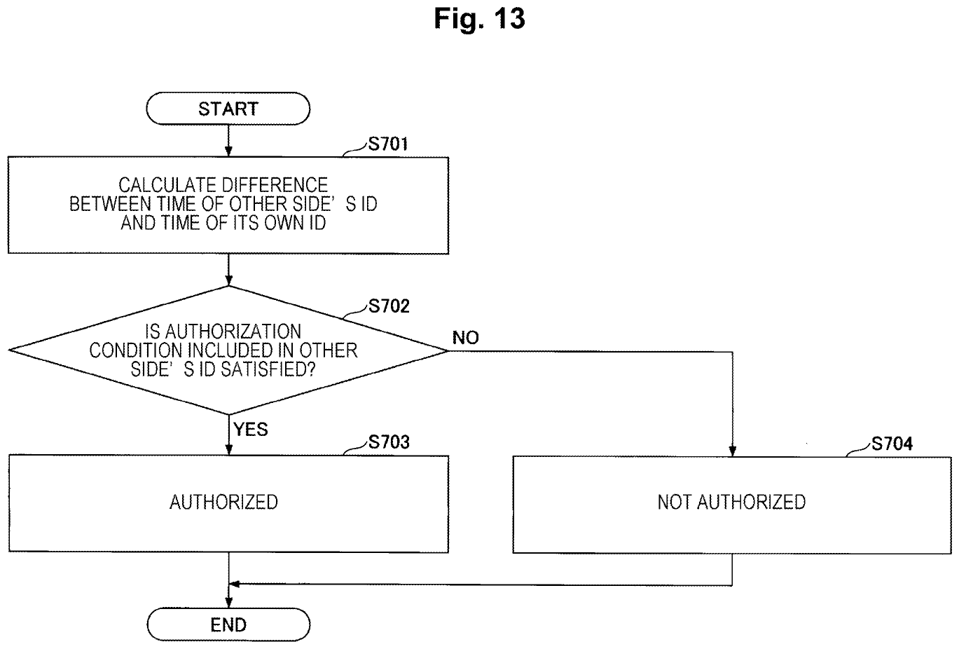

The authorization verification processing (authorization verification processing in step S202 in FIG. 7) in Example 4 will be described with reference to FIG. 13. FIG. 13 is a flowchart illustrating the authorization verification processing in Example 4. Note that, in the authorization verification processing illustrated in FIG. 13, as in the case of Example 1, as an example, it is assumed that the device 20A is the authorizing device 20, and the device 20B is the authorized device 20.

The authorization verification unit 203 of the device 20A calculates a difference between the time indicated by the time information included in the ID of the device 20B and the time indicated by the time information included in its own ID (step S701).

Next, the authorization verification unit 203 of the device determines whether or not the difference calculated in step S701 above satisfies the authorization condition included in the ID of the device 20B (step S702).

Then, the authorization verification unit 203 of the device 20A determines that the device 20B is authorized in a case where it is determined that the authorization condition is satisfied in step S702 above (step S703), and determines that the device 20B is not authorized in a case where it is determined that the authorization condition is not satisfied in step S702 above (step S704).

For example, it is assumed that the ID of the device 20A is “sensor01_202007212137_around3 days” and the ID of the device 20B is “sensor02_202007221630 around1day”. In this case, a difference between “202007221630” and “202007212137” is calculated in step S701 above, and it is determined in step S702 above whether or not the difference satisfies the authorization condition “around1day” (that is, within one day). In this example, since the difference between “202007221630” and “202007212137” is within one day, it is determined that the device 20B is authorized.

On the other hand, for example, in a case where the ID of the device 20A is “sensor01_202007212137_around3 days” and the ID of the device 20B is “sensor02_202007251630_around1day”, it is determined that the device 20B is not authorized.

In this way, in the present example, the authorizing device performs the authorization verification according to the authorization condition included in the ID of the authorized device 20. This means that the authorization condition included in the ID 20 of the authorized device is treated as the expiration period of the ID. As a result, for example, in a case where a new ID has not been distributed to the authorized device 20 for a while, the authorized device 20 can be prevented from being authorized.

The present invention is not limited to the above-mentioned specifically disclosed embodiment, and various modifications and changes, combinations with known technique, and the like can be made without departing from the scope of the claims. In addition, the above-described examples can be appropriately combined as long as there is no contradiction therebetween.

### REFERENCE SIGNS LIST

1 Authentication and authorization system
10 Authentication and authorization infrastructure
11 Input device
12 Display device
13 External I/F
13a Recording medium
14 Communication I/F
15 Processor
16 Memory device
17 Bus
20 Device
21 Communication I/F
22 Processor
23 Memory device
24 Bus
101 Communication unit
102 Time management unit
103 Device information management unit
104 Authorization condition management unit
105 ID generation unit
106 Registration processing unit
107 Private key generation unit
110 Storage unit
201 Communication unit
202 Mutual authentication unit
203 Authorization verification unit
204 Time measurement unit
210 Storage unit
N Communication network

1. An authentication and authorization system comprising:
a plurality of devices that perform mutual authentication and authorization by an authentication protocol using ID-based encryption; and
an authentication and authorization infrastructure that generates an ID and a private key used for the mutual authentication and authorization,
wherein the authentication and authorization infrastructure includes:
a first memory; and
a first processor coupled to the first memory and configured to
generate an ID including at least an identifier of the device and information regarding the device;
generate a private key of the device from the ID; and
distribute the ID and the private key to a device corresponding to the identifier included in the ID, and
the device includes:
a second memory; and
a second processor coupled to the second memory and configured to
perform mutual authentication with another device by using the ID and the private key of the own device;
verify whether or not a predetermined authorization condition is satisfied by using information regarding a device included in the ID of the own device and information regarding a device included in the ID of the other device when the mutual authentication is performed with the other device; and
authorize a request from the other device to the own device when it is verified that the authorization condition is satisfied.

2. The authentication and authorization system according to claim 1, wherein the authorization condition is any of an authorization condition included in the ID of the own device, an authorization condition included in the ID of the other device, or a predetermined authorization condition.

3. The authentication and authorization system according to claim 1, wherein the second processor calculates a difference between the information regarding the device included in the ID of the own device and the information regarding the device included in the ID of the other device, and verifies whether or not the calculated difference satisfies the authorization condition.

4. The authentication and authorization system according to claim 1, wherein the second processor is further configured to:
measure a change in a state of the device from time when the ID and the private key distributed from the authentication and authorization infrastructure are received,
calculate a difference between information obtained by adding the change to the information regarding the device included in the ID of the own device and the information regarding the device included in the ID of the other device, and
verify whether or not the calculated difference satisfies the authorization condition.

5. The authentication and authorization system according to claim 1, wherein the ID includes one or more objects to be authorized and authorization information corresponding to each of the objects, and
the second processor verifies whether or not an authorization condition corresponding to the object is satisfied for each of the objects.

6. A device that performs mutual authentication and authorization by an authentication protocol using ID-based encryption, the device comprising:
a memory; and
a processor coupled to the memory and configured to
perform mutual authentication with another device by using an ID and a private key distributed from an authentication and authorization infrastructure;
verify whether or not a predetermined authorization condition is satisfied by using information regarding a device included in the ID of the own device and information regarding a device included in the ID of the other device when the mutual authentication is performed with the other device; and
authorize a request from the other device to the own device when it is verified that the authorization condition is satisfied.

7. An authentication and authorization method used in an authentication and authorization system including a plurality of devices and an authentication and authorization infrastructure, the plurality of devices performing mutual authentication and authorization by an authentication protocol using ID-based encryption, the authentication and authorization infrastructure generating an ID and a private key used for the mutual authentication and authorization, the authentication and authorization method comprising:
steps executed by the authentication and authorization infrastructure, including
generating an ID including at least an identifier of the device and information regarding the device,
generating a private key of the device from the ID, and
distributing the ID and the private key to a device corresponding to the identifier included in the ID; and
steps executed by the device including
performing mutual authentication with another device by using the ID and the private key of the own device,
verifying whether or not a predetermined authorization condition is satisfied by using information regarding a device included in the ID of the own device and information regarding a device included in the ID of the other device when the mutual authentication is performed with the other device, and
authorizing a request from the other device to the own device when it is verified that the authorization condition is satisfied.

8. A non-transitory computer-readable recording medium storing a program causing a computer to function as the authentication and authorization infrastructure or the device included in the authentication and authorization system according to claim 1.
